(19) United States
(12) Patent Application Publication
(10) Pub. No.: US 2007/0268261 A1
(43) Pub. Date: Nov. 22, 2007

(54) HANDHELD ELECTRONIC DEVICE WITH DATA ENTRY AND/OR NAVIGATION CONTROLS ON THE REVERSE SIDE OF THE DISPLAY

(76) Inventor: Erik Lipson, Philadelphia, PA (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/749,926

(22) Filed: May 17, 2007

Related U.S. Application Data
(60) Provisional application No. 60/801,030, filed on May 17, 2006.
(60) Provisional application No. 60/807,989, filed on Jul. 21, 2006.
(60) Provisional application No. 60/868,736, filed on Dec. 6, 2006.
(60) Provisional application No. 60/891,350, filed on Feb. 23, 2007.
(60) Provisional application No. 60/895,520, filed on Mar. 19, 2007.

(51) Int. Cl. G09G 5/00

(52) U.S. Cl. 345/169

(57) ABSTRACT

A handheld electronic device has a display screen on a front planar surface and a command entry structure comprising a keyboard on a rear planar surface parallel to the front planar surface. Mirror images of the rear keys are displayed on the screen and are highlighted when a key is touched. The user further depresses the touched key to confirm the command. The keyboard has a unique configuration which allows touch typing.

### RELATED APPLICATIONS

This application claims priority of U.S. Provisional Patent Applications Ser. Nos. 60/801,030 filed May 17, 2006; 60/807,989 filed Jul. 21, 2006; 60/868,736 filed Dec. 6, 2006; 60/891,350 filed Feb. 23, 2007; and 60/895,520 filed Mar. 19, 2007, which are incorporated herein by reference.

### FIELD OF THE INVENTION

This invention relates to a portable handheld electronic communication device including a display screen and a command entry structure such as a keyboard, a touch screen, or a navigation nib, which might constitute a cell phone, PDA, computer, TV remote, GPS, camera, or the like, and more particularly to a compact configuration for such a device with a generally planar display on the front side and a generally planar command entry structure on the reverse side.

### BACKGROUND OF THE INVENTION

A wide variety of electronic devices are designed to be handheld. These devices generally have a planar configuration and must incorporate a display screen and means for entering messages or commands by the operator, usually both on the front or face of the device. Because they must share this face, both are necessarily of compact configuration. When the user entry device is a keyboard, of the type employed on typewriters or personal computers, the space required is substantially larger than the space available on that part of the face of the handheld device which is not used by the display, and a variety of schemes have either been proposed or implemented for incorporating both a display screen and a keyboard in a handheld device, Similarly, when the device is a remote control or the like in which keys must be provided for entering user commands, little space is left on the face of the device for incorporation of a display screen of a desirable size. The command or data entry device may include or comprise a touch-sensitive panel either above or in connection with keys and/or a navigation nib.

All of these devices involve compromises in terms of the size of the display screen and the command structure, necessitated by these two units sharing the common face of the handheld device.

At the same time the rear side of a handheld device, usually held facing away from the user, is left blank. Typically the handheld device is supported with the fingers of one or both of the user's hands on this blank rear side of the device, while one or both of the user's thumbs press against the face of the device.

### SUMMARY OF THE INVENTION

The present invention is accordingly directed toward a handheld electronic device having a display screen occupying a large part or all of the front of the device, which is typically planar and held facing the user, and having a command or communication entry structure formed on the opposite side from the display, on the rear of the device, where it may be actuated by the user's fingers. The device is often held sandwiched between the user's thumb and the forward-facing fingers on the rear face. These devices usually have rectangular front and rear faces and are thin, with the faces substantially parallel to one another.

In order to allow the user to determine the position of the controls, so that the user's fingers may be positioned to properly actuate the controls despite the fact that the controls are on the reverse side of the device which is held facing away from the user, the present invention contemplates that the electronic system of the device generates images of the controls which are displayed on the front screen of the unit. These images may be dimmed to “phantom images” when other information is displayed on the screen. Moreover, the intensity and/or the depiction of the images may be varied when they are contacted by the user's fingers, to feed back to the user the proper location of the fingers to actuate the desired control or data input function. A fingerprint may appear on screen on the visual choice enacted by the button the finger is on. The user then presses the button harder to select the choice. Numerous fingerprints could be displayed at one time when numerous fingers are touching the corresponding buttons. In this way the user gets a feel for where all of his fingers are, and what they are about to choose.

Small Braille-like bumps can be placed on some of the buttons on the bottom to aid the user in knowing which button he is about to press. These Braille bumps can be shown on the screen by the graphical image of the corresponding buttons. A checkerboard bump pattern on the button layout that is shown on screen is very helpful. Every other button may be smooth and the interlaced buttons may have one bump on them. A Braille system, where every other button on the second row has two bumps on it, may be employed.

In a preferred embodiment of the invention which will subsequently be disclosed in detail, the finger-actuated controls or command structures on the rear of the device are effectuated by keys in the form of a keyboard. The key layout could be a simple button matrix. The matrix could cover the whole back of the screen. In this way it could act very much like a normal front acting touch screen, but without the user's fingers blocking the view of the screen or smudging the visual screen. A visual picture of any electronic device could be displayed, with buttons underneath corresponding to all of its controls. A cursor pointer could also be used to select the depicted buttons. The depiction of these familiar devices could be real three-dimensional, catalog type pictures, so the user feels familiar with what he is looking at and how it works. With location information from GPSes and online registered locations of devices and radio signals and the like, it will be possible for this device to visually chance into a familiar form to control anything the device knows is around the user. Not only will the proper visual information be displayed, but the button and communication protocols can also be downloaded in real time so that the unit will also function as the depicted device. The key arrangement may range from a few buttons to a full alphanumeric keyboard. The keys may be the sole entry mechanism or the rear side may also include or consist of one or more touch-sensitive panels as will be subsequently described. By provision of the keys or keyboard on the reverse side of the device, the major portion of the entire surface of the front of the device may be used for a large display screen for easy viewing and the provision of detailed text and graphics such as video.

In one embodiment of the invention, subsequently described in detail, the keyboard is arranged in a unique configuration so that a person skilled in touch typing can quickly adapt to use of the novel device. In this embodiment a conventional QWERTY keyboard is essentially split vertically into two sections. Each section is rotated by ninety degrees in an opposite direction about adjacent upper corners. For example, the two vertical lines of keys arrayed on opposite sides of the center of the novel keyboard may respectively contain the characters QWERTY and POIUY. The left section is then rotated by ninety degrees in a clockwise direction about the Q key, and the right section is rotated by ninety degrees in a counterclockwise direction about the Y key. The key arrangement is then flipped or rotated laterally by one hundred eighty degrees.

When the operator holds the handheld device with two hands, with the thumbs on the forward side or side edges of the device and the fingers on the reverse side, the operator's fingers underlie the keyboard and are rotated by ninety degrees, in opposite directions, relative to the normal touch-typing position on a conventional keyboard. Thus, the operator's fingers are arrayed over the same keys that they would be on a conventional keyboard. For example, the two forefingers are in a position to contact the letters T and Y.

In one embodiment, the novel key layout appears as a low intensity, “ghost” image on the display screen, to aid the user in properly positioning fingers on the keyboard. As text is typed on the keyboard it appears on the display screen as conventional, darker images, overlying the ghost images of the keyboard. The operator may extinguish the ghost image if preferred.

The keyboard may incorporate one or more space buttons to allow for nonuse of the thumbs, but the device could incorporate a special button or buttons actuated by the user's thumbs to keep the appropriate typing feel. By way of example, the unit may have two buttons, one by each thumb, which would be activated by squeezing the thumbs together to initiate a spacebar command. Similar arrangements could be employed to generate numbers from the keyboard.

An embodiment of the invention which will subsequently be disclosed in detail comprises a handheld electronic device which has a forward face, the majority of which is occupied by a display screen. The rear face, parallel to the forward face, incorporates a keyboard which occupies a portion of the back, and a touch screen. If the rear of the device is to be used as a camera, as well as other handheld electronic devices, it also incorporates a camera lens. The back may also use a mouse nib to control the cursor instead of a touchpad. The nib takes up less space and can allow for more buttons and/or a smaller device. The back of the device could be almost completely filled with buttons with the camera lens and nib built into the back edge of the device.

When the device is initially turned on, the front display screen incorporates an array of icons which deal with the various functions that the device can perform, such as a word processor, a telephone, a camera, a GPS device, a game player, etc. One of these icons can be selected by touching keys on the back. When the user's fingers touch the keys, the particular icons they are associated with are highlighted or illuminated to show the user which key is being touched. A further depression of a selected key will enable the function associated with the selected icon. For example, with the word processing function a keyboard will appear on the display screen and by pressing one of the buttons on the keyboard on the reverse of the device, that display segment will be illuminated and can then be further depressed to generate the key. Any material typed will appear above the keyboard on the front display screen and can be transmitted as an email, a text message or preserved for later reproduction. By depressing select keys, the buttons and their symbols can be limitlessly relabeled to produce any symbol in the world. The button symbols and their associated typed symbols could be in Chinese, Arabic, Hebrew, Yiddish, etc. They could be mathematical or scientific notations. This would all be just more software and easily downloadable. Someone could write software to use ancient Egyptian symbols as a current fun language that would be able to be typed and depicted on this unit. Also, new, not yet invented symbols and icons can be implemented easily without changing the unit's hardware, but just by writing and downloading new software. In this way the unit and keyboard are not static, but can evolve with the times.

Similar functions are generated by enabling the other icons which appear on the initial screen. The touchpad on the rear of the device is used in connection with many of the functions. For example, when the OPS function is enabled and a map is displayed on the front display screen, motions of the finger along the touchpad will move the map segment being displayed in a corresponding direction.

The device of the present invention may incorporate structure that may be engaged by the user's thumbs to assist in supporting and stabilizing the device, such as flexible loops or tubes on opposed edges of the device. Alternatively, the portable device might be formed in two planar sections, hinged at one edge, so that it may be open for the thumbs to be inserted and sandwiched between the sections when closed, for more stability. The hinge arrangement might allow the device to fold so that the screen and keys face each other during storage and nonuse. When partially open, the unit could be used and configured as a small normal laptop. When all the way open and folded back on itself, it would then be in its new mode.

In another embodiment the front screen is in two sections, so the unit can be folded in half for safe storage when not in use. When not in use, the two halves of the screen face each other and the control buttons and devices are in two halves on the outside. In another embodiment, the device may be attached to a larger device with a hinge or cord. This allows this flexible input structure to control almost any device. These embodiments might also employ an attached stand so it could be supported on a desk. This would be beneficial if one wants to watch a video. The stand could be in the form of a kickstand that pops out when desired but retracts for all other uses.

In an embodiment of the invention in the form of a remote controller for TVs, lights or the like, an image of the key arrangement visible on the front display screen allows the operator to actuate the keys which are arrayed on the back of the device. The full screen could also provide full video images, email messages or the like.

In another embodiment of the invention, the finger-actuated controls or command structures on the rear of the device include or comprise a touch-sensitive panel. A variety of schemes for making panels touch sensitive have been implemented or proposed including capacitive sensors, membrane sensors, magnetic sensors, resistive sensors or the like. These devices are of the type broadly classified in class 345, subclass 173 of the U.S. Patent Office classification system. Broadly they provide electrical signals based on the position at which they are contacted by a finger. By associating controls with various positions, the user may activate the controls by touching particular regions of the touch-sensitive surface on the rear of the handheld device.

These touch-sensitive screens may be of the type that generate an absolute position, so that by touching a point on the screen, a complementary point on the display will be energized. Alternatively, the touch-sensitive screen may be of the type used as a mouse on some computers in which a motion of a finger on the touch screen drags a cursor through an equivalent distance on the display.

For example, it would be possible to implement a PDA (personal digital assistant) in the form of the present invention with a full display screen on one side of the device and touch-sensitive controls on the opposite side. This would allow the screen to display graphical information, text, video information, or the like in a relatively large scale. The controls for the device could be actuated by touching selected areas on the touch-sensitive screen with any or all of the eight fingers of the hands which are on the rear of the device, while the device is being held with the user's thumbs on the forward two opposed edges. The positions of the controls could be signaled to the user by phantom displays on the forward display panel in positions associated with the touch areas on the rear of the panel. These displays could be increased in intensity when the user touches a particular area to indicate the area being touched.

With both the touch-sensitive screens and the keyboards, either or both of which may be incorporated on the rear of various embodiments of the present invention, various techniques may be used to ensure that a desired command is being entered before the command is verified by a second key press or by an increased pressure in the activated area. For example, the structures disclosed in U.S. Pat. Nos. 5,311,175 or 6,215,417 might be employed as well as alternative, functionally similar systems. The operator could then touch a selected area on the command structure and based upon the indication of the area touched as indicated on the display panel, verify the command by again touching the area or pressing harder on the area.

All of the controls on the rear of the device are preferably arrayed in a mirror image of the way they appear on the front of the device. Thus when the control is a navigation ring that has controls for movement to the right, left, up and down, a contact on the left side of the ring, if viewed from the back, would produce motion to the right and vice versa.

In one embodiment of the invention the touch screen on the rear of the device allows control of the movement of an icon such as a cursor or arrow, which is imaged on the front screen, in the same manner as a touchpad allows cursor control in many laptop computers. The cursor may be moved into overlapping position with icons or symbols displayed at particular positions on the front display screen. For example, the front screen could display a full QWERTY keyboard and text could be generated by bringing the cursor into position with one letter of the screen after another. Again, the icons or characters on the screen could be of reduced intensity so that the resulting text appears over the characters; alternatively the text could appear on one portion of the screen while the characters are displayed on another portion of the screen. When the cursor has been moved into position with the desired icon or character, the command signified by that icon or character could be implemented by either depressing keys which might be associated with thumbs on the front of the device or by the previously noted techniques for tapping on the selected cursor after the cursor is in position.

The devices of the present invention could be used to implement a wide variety of electronic devices requiring a screen and controls, such as a cell phone, PDA, remote control for a television and the like, still cameras, video cameras, MP3 players, games, GPS devices, etc.

The devices of the present invention all enjoy the advantages of a full screen occupying the front of the device and a full command structure on the rear of the device. The screens of the devices formed in accordance with the present invention, because they are full sized and can be placed as close to the eyes as a laptop, appear almost as large as a laptop's to the user. Despite this large screen size the unit can easily be carried around in a pocket or pocketbook. The devices, with GPS and other proximity information, can “morph” into any device appropriate to the devices around it. In this way, if you go to a friend's house whose TV's serial number and location and communication protocol are registered on the Internet, the device would know it was close and could download the appropriate display and key labeling information and communication protocol to control the TV it is near. With a built-in compass, the unit would even know when it is pointed at the TV. If the device is attached to the Internet, the communications and control could go through the Internet to control the TV or device. This “morphing” and control communication could happen seamlessly based on where you are and what you are around.

### BRIEF DESCRIPTION OF THE DRAWINGS

Other objects, advantages and applications of the present invention will be made apparent by the following detailed description of several preferred embodiments of the invention. The description makes reference to the accompanying drawing in which:

FIG. 1 is a perspective view of the front screen of a preferred embodiment of the invention being held by a user's hands so that the front is opposed to the user's face;

FIG. 2 is a perspective view of the preferred embodiment of FIG. 1 as held by a user's hands from the rear side, illustrating the user's fingers on the data entry side, or reverse of the device;

FIG. 3 is a view of the front display panel of an alternative embodiment of the invention illustrating a mirrored phantom display of the control and input keys on the reverse side of the device to aid the user in properly actuating the desired controls;

FIG. 4 is a rear view of the device of FIG. 3 illustrating the command and data entry structure;

FIGS. 5A-5F are diagrams illustrating the manner that a conventional QWERTY keyboard is bisected and manipulated to generate the BGTYHN keyboard of the present invention;

FIG. 6 is a front perspective view of an alternative embodiment of my invention illustrating the front display screen showing icons which represent the choices for functional use of the device;

FIG. 7 is a rear view of the embodiment of FIG. 6 illustrating the data and command entry structure which comprises both a keyboard and an incremental type touchpad or “mouse” pad;

FIG. 8 illustrates the display screen when the “word processing” icon on the front display screen has been energized through appropriate manipulation of the data and command entry structure on the rear of the device;

FIG. 9 is a front view of the device of FIG. 6 illustrating the icons shown on the display screen when the “movies” icon on the initial display screen has been energized;

FIG. 10 is a front view of the device of FIG. 6 illustrating the display screen when the “Internet” icon on the front of the initial screen as shown in FIG. 6 has been energized;

FIG. 11 is a front view of the display screen of the device of FIG. 6 when the “phone” icon shown in the initial display screen is appropriately energized;

FIG. 12 is an illustration of the front display screen of the device of FIG. 6 showing a map that is called up when the “GPS” icon on the front display screen as shown in FIG. 6 is appropriately energized;

FIG. 13 is a diagram illustrating the manner in which controls on the rear of a device of the present invention are mirrored on the front display panel to aid the user in properly actuating the controls;

FIGS. 14A and 14B are a front perspective view and a rear perspective view respectively of a camera formed in accordance with the present invention;

FIG. 15 is a perspective view of the front of a cell phone formed in accordance with the present invention being held in the user's hands so that the display faces the user;

FIGS. 16A, 16B and 16c are, respectively, views of a laptop personal computer incorporating the present invention in opened form, in a first closed form presenting a display screen on one side and a command and data entry structure on the opposite side, and a second closed form in which the screen and entry structure are secured in opposition on the interior of the device; and

FIGS. 17A and 17B are a front perspective view of a video camera formed in accordance with the present invention and a display on the screen of the video camera, visible to the user, respectively.

### DETAILED DESCRIPTION OF THE PREFERRED EMBODIMENTS

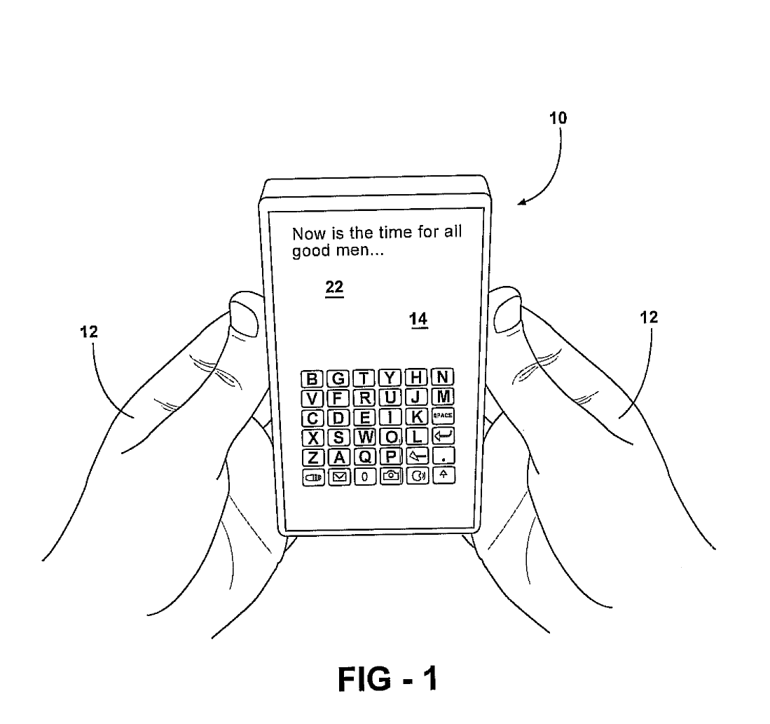

FIGS. 1 and 2 disclose a preferred embodiment of the invention, generally indicated at 10, which preferably constitutes a combination cell phone and PDA, often termed a “smart phone”. The preferred embodiment of the device is adapted to be held between the user's hands 12, with the thumbs pressed against the sides of the unit 14 and the fingers arrayed along the bottom side 16. The device 10 is preferably rectangular. The major dimension, in the case of the preferred embodiment the height, but alternatively the width in alternative embodiments, is preferably less than eight inches and typically about four inches. The minor dimension, in the case of the preferred embodiment the width, may range from four inches to slightly less than two inches. The thickness between the two planar faces 14 and 16 will typically not exceed one and three-quarter inches, and may preferably be about one-half of an inch, or thinner as technology permits.

The housing of die unit 10 supports the associated electronics which in the case of a smart phone will include memory, which may include semiconductor memory and/or hard disc memory, various semiconductor structures which control the operating system, the display, and communications, and a transceiver for communicating with remote devices, which may constitute a typical cell phone transceiver, a Wi-Fi chip, Bluetooth, or the like. The structures are all conventional, and differ in design as the technology advances.

The front panel 14 of the device 10, which is typically held opposite the user's face, is occupied primarily or entirely by a display screen, preferably of the LCD variety. The display screen is normally substantially planar. The rear side 16 of the device 10 is also substantially planar and is normally disposed approximately parallel to the front display screen 14. It carries a finger-actuated command or data input structure which in the device 10 constitutes a keyboard 18. In other embodiments of the invention, the rear surface 16 of the device may comprise a touchpad, or include various key structures along with touchpad structures.

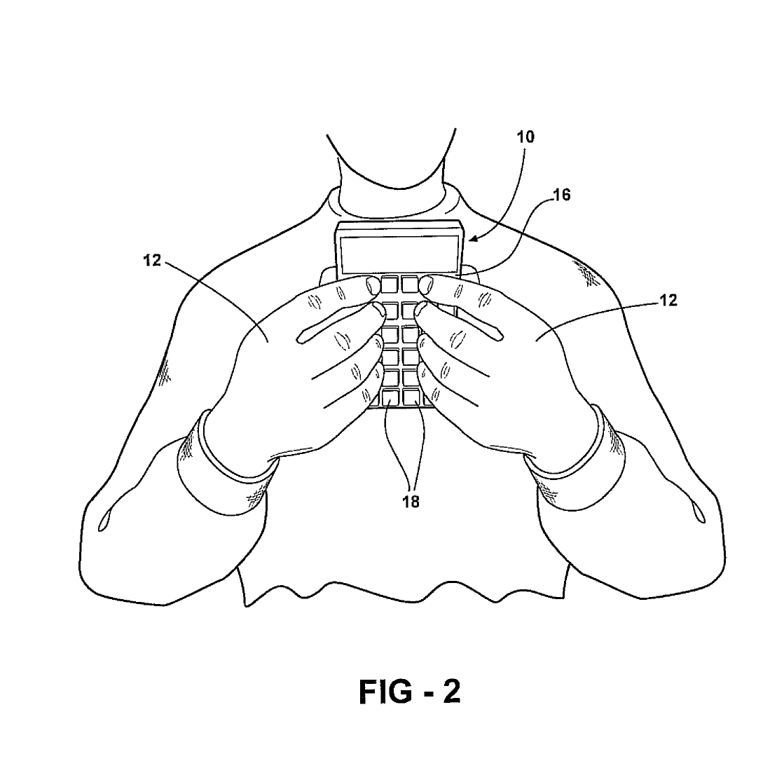

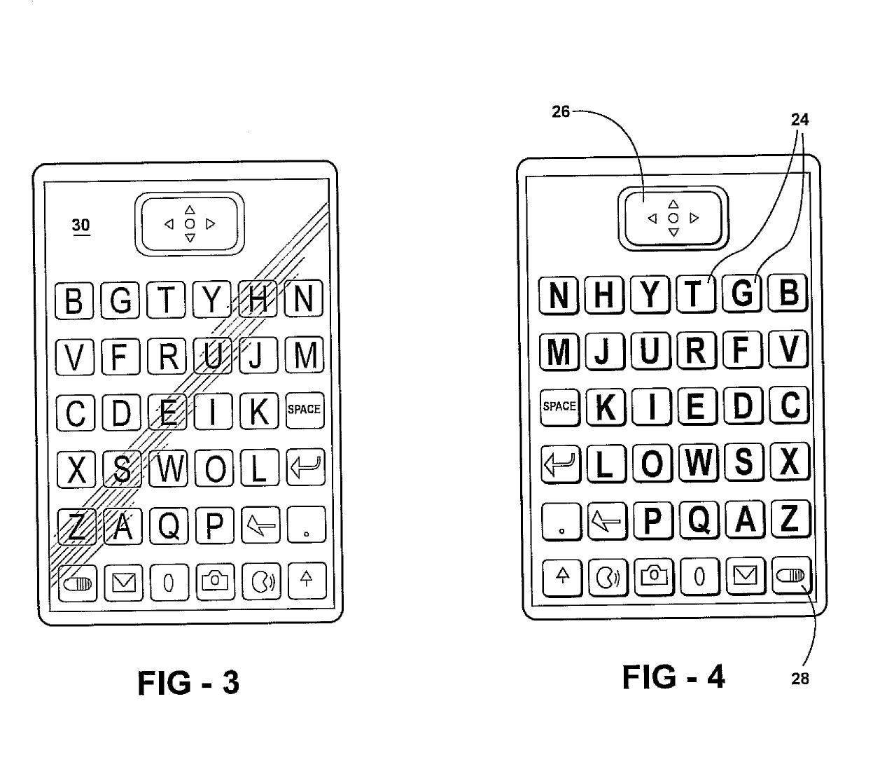

The keyboard 18 in the preferred embodiment is a full alphanumeric keyboard which will be disclosed in detail in connection with FIGS. 3 and 4.

Since the rear 16 of the device 10 is not visible to the user when held in the manner illustrated in FIGS. 1 and 2, to aid the user in the proper placement of her fingers at appropriate locations on the rear 16 in order to enter desired commands or data, the electronic circuitry within the device 10 generates a display 20 on the display screen 14 which mirrors the location of the appropriate command or data entry points on the rear of the device. This display 20 is generally of a lower intensity than the displays generated by the touching of command or data entry points on the rear of the device and the display may be extinguished when the user has become thoroughly familiar with the arrangement of the entry locations.

As will subsequently be described, low intensity images may be increased in intensity, or a new image like a fingerprint superimposed on top of the image, when the user brings a finger into contact with the particular command or data entry area on the rear of the device to indicate to the user the point being touched and allowing the entry to be confirmed by an additional tap on the location or increased pressure in the location. This may be achieved by arrangements of the type of disclosed in U.S. Pat. Nos. 4,700,377; 5,311,175 or 6,215,417 or the like.

In the preferred embodiment of the device 10, alphanumeric entries made on the rear of the device appear in the area 22 above the phantom images 20.

The entire display screen may be used to display inputted information or text or graphics received by the telecommunications section of the device 10. For example, it could be used to surf the Internet, display web pages, or as a receiver for streaming video generated through the Internet or by TV broadcast. It can also be used to view the contents of the memory section of the device 10 including contact information, received emails, sent emails, etc. When the device 10 is in communication with appropriate sources it can also display maps, charts, and all other forms of graphic information. Because of the large size of the display screen 14 relative to the displays of other devices which must share the front face with command or data entry structures, the displays can be in large, relatively easily readable size, or can incorporate much more detail than comparable displays on cell phones and the like.

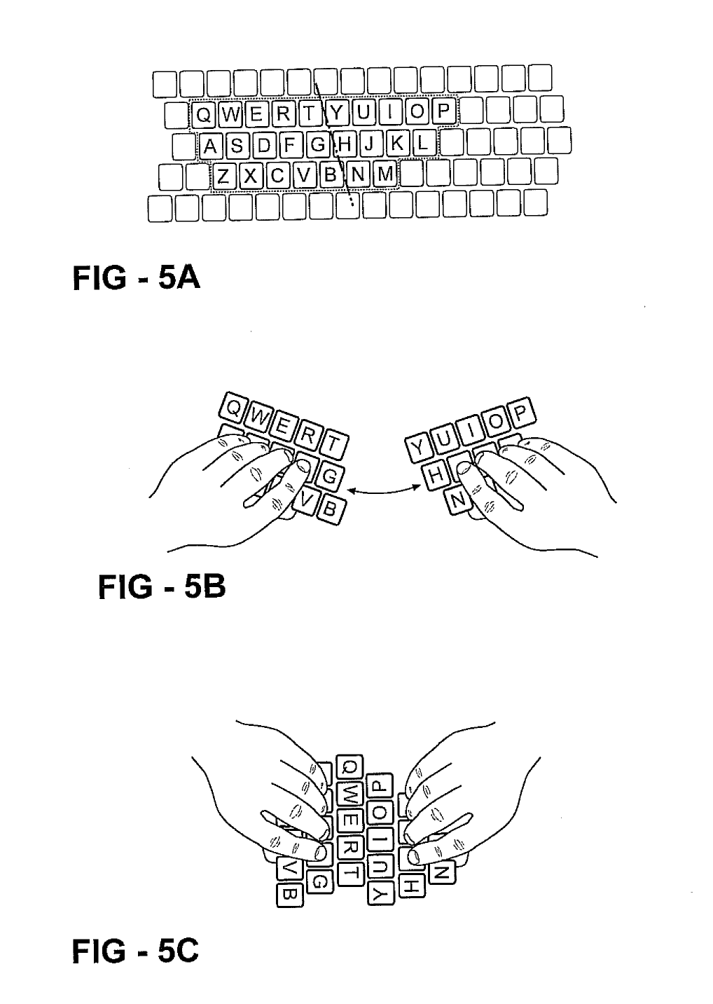

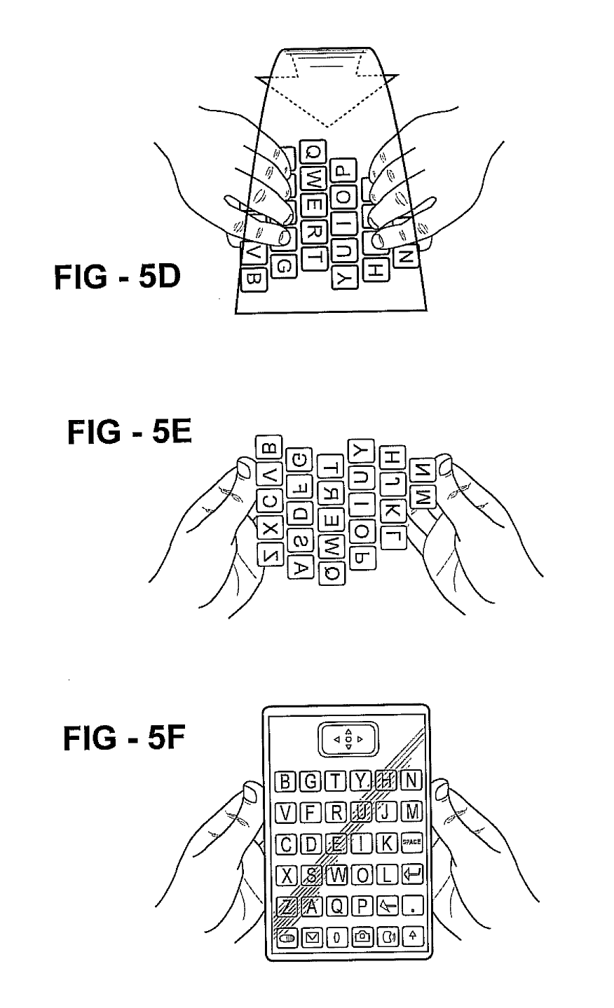

FIGS. 3 and 4 illustrate an alternative embodiment of the invention in which the rear of the device, illustrated in FIG. 4, incorporates an alphanumeric keyboard of a unique configuration, as well as other command keys and navigation aids and FIG. 3 illustrates the mirrored phantom images of the rear controls as displayed on the front panel of the device. The rear keyboard includes a set of keys 24 that are arranged in an unusual configuration, which is derived from the normal QWERTY configuration in the manner illustrated in FIG. 5. The rear side also includes a navigation ring 26 which allows the user to control motions in the front panel in up, down, left or right directions and to select a particular choice by pressing the center bar. The bottom row of keys 28 includes various icons which may select various functions of the device. The front panel 30 of the device, illustrated in FIG. 3, incorporates mirror images of all of the controls on the rear side to assist the user moving fingers into position over the proper controls. Like the other embodiments, the controls are provided for extinguishing the phantom images and phantom images may be increased in intensity when the finger is brought into position with respect to them. The function and labeling of the keys in FIG. 3 can be limitlessly changed. The actual keys in FIG. 4 do not have to be labeled.

In alternative embodiments the keys 24 and navigation ring 26 might be displaced toward the bottom of the rear panel, so that the display screen on the forward side of the device does not contain any phantom images, in the manner of the display screen of FIG. 1, allowing text that is typed on the rear panel to be displayed on the top section, above the phantom images.

The keys 24 in the device of FIG. 3 are arranged in a configuration that differs from the conventional QWERTY keyboard that is familiar to typists. This unique arrangement allows the operator's fingers to touch type on the rear panel, when the device is held in the manner illustrated in FIG. 2, in a manner similar to the way touch typing is normally done with a conventional QWERTY keyboard. The different configuration is required because the operator's hands 12, as illustrated in FIG. 2, are rotated and inverted relative to their positions on a normal keyboard.

FIGS. 5A-F illustrate the manner in which a keyboard arrangement illustrated in FIGS. 2 and 3, which will be termed a BGTYHN arrangement because of the configuration of the top line, is arrived at. FIG. 5A illustrates a conventional QWERTY keyboard. To arrive at the BGTYHN keyboard, the QWERTY keyboard is split along a vertical line into two sections. Although the exact division is not critical, I chose to divide it so that the letters TGB are on the left side of the division and the letters YHN are on the right side.

The next operation, illustrated in FIG. 5B, involves rotating each of the two sections derived in FIG. 5A by ninety degrees in opposite directions, about the two top row letters T and Y. The resulting keyboard is then flipped about a horizontal axis through one hundred eighty degrees, as illustrated in FIGS. 5C and 5D, to arrive at the BGTYHN configuration illustrated in FIG. 5E. The two sections are then squared up to the form illustrated in FIG. 5F which shows the phantom view of the front display screen of the device.

In moving the user's finger positions from the convention QWERTY keyboard to this unique BGTYHN keyboard, the hands undergo motions complementary to the divisions illustrated in FIGS. 5A-5E and the fingers thus lie on the rear keys in the same manner as they would like on a conventional QWERTY keyboard. For example, on a conventional QWERTY keyboard the forefingers of the two hands are arrayed over the letters T and Y. After rotation of the hands to the form illustrated in FIG. 2, the forefingers also lie over the letters T and Y. Thus a typist who can touch type on a conventional keyboard can quickly learn to use the keyboard of the present invention, aided in particular by the phantom images of the keys on the front screen of the device.

In alternative embodiments of the invention, the entire front display need not be occupied by the display screen 14 illustrated in FIG. 1, but a relatively few controls, such as an on-off switch or a dimming switch, might be included on an edge of the front panel so as not to interfere with use of the large part of the panel for display purposes. It could also have speakers and a microphone somewhere on these edges. The screen 14 will preferably occupy at least 75% of the front of the device.

The rear panel of devices formed in accordance with the invention, such as the section 16 of the device 10 illustrated in FIGS. 1 and 2, may comprise a touchpad or it may consist of a hybrid command and data entry structure comprising both keys and one or more touchpads or touch screens. These devices may be of the absolute type, wherein touching a point on the touch screen generates a control signal which activates or illuminates a corresponding point on the front display panel, possibly energizing a function designated by an icon displayed on the front display screen, or alternatively, an incremental type control wherein a motion of the user's finger or a stylus along the touchpad or screen moves a cursor or the like on the front display panel in a corresponding direction and distance. The latter type of touchpad is commonly employed as a mouse for a laptop computer. It might also use a mouse nib, as used in some earlier laptop keyboards.

By displaying suitable symbols or icons at particular areas on the front display screen, and by energizing them by signals generated by moving a cursor displayed on the front panel under control of finger motions on the touch panel, a wide variety of data and/or command entries may be achieved. Thus the front panel may include symbols of a keyboard and messages may be sent by successively contacting and energizing the icons through motions of the touchpad. Alternatively, various functions of the device, like those capabilities provided to a cell phone, may be energized by selection of icons through the touchpad-induced motions. As has been noted, various known techniques may be used to assure the proper position of a control signal generated by motions on the touchpad before the proper function is energized.

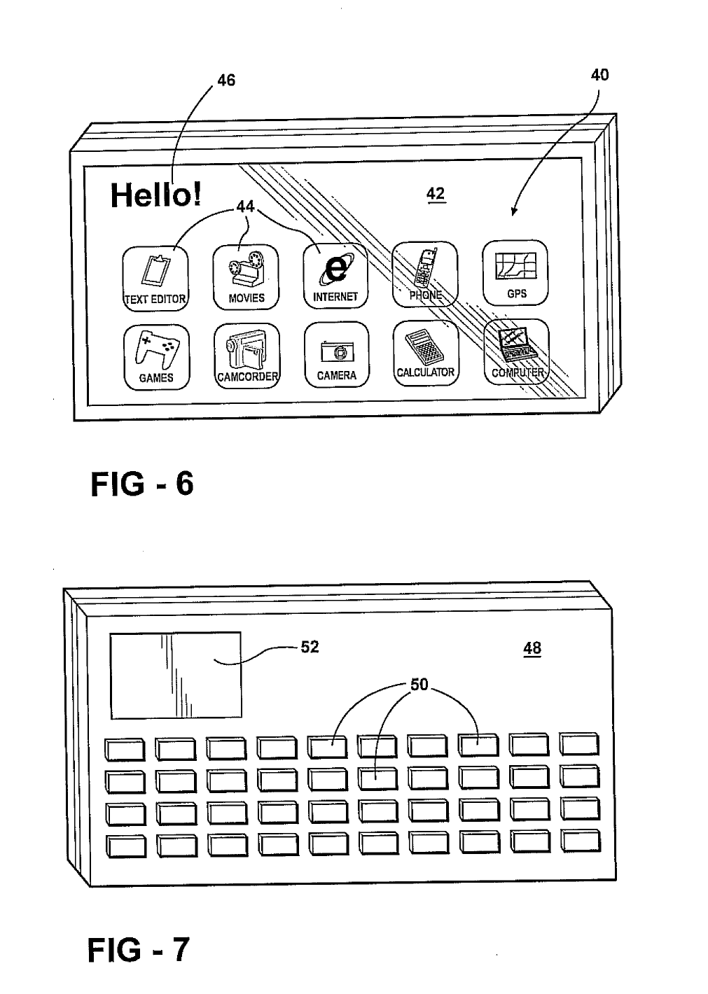

FIGS. 6 and 7 respectively illustrate the front and the rear sides of an alternative embodiment of a handheld electronic device formed in accordance with the present invention. The front of the device, generally 40, illustrated in FIG. 6, supports a display screen 42 which occupies almost the entire area of the front 40. Tile display screen shown in FIG. 6 constitutes the initial screen, generated when the device is first turned on by an appropriate on-off button, which may include part of the command structure on the rear of the device, illustrated in FIG. 7. The initial screen includes a select number of icons 44 which provide the user with choices for the basic function of the device. Ten icons are shown such as “text editor”, “movies”, “Internet”, “phone”, “GPS”, “games” and the like. These icons 44 are arrayed in two rows along the bottom of the screen; the top of the screen includes a message 46 to the user related to the functional choices.

The rear 48 of the device incorporates the command and data input structure. In this embodiment it comprises four rows of keys 50, arrayed along the bottom of the rear 48, and a touch screen 52 formed at one side of the top. The touch screen is preferably of the gesture or incremental type, in which motions of the fingers along the touch screen move an appropriate icon on the front display screen 42 under control of an appropriate microprocessor based operating system located within the device.

In a variation of the device of FIGS. 6 and 7, the touch screen 52 could be replaced by a roller type mouse or mouse nib, allowing control of a cursor displayed on the front of the screen.

In order to place the device into a selected operating mode represented by one of the icons 44, the user actuates the command and data structure on the rear of the device in an appropriate manner. In a preferred manner, when the initial screen with the icons 42 is displayed, one or more of the keys 50 on the rear of the device are associated with each icon. For example, the icon representing “word processing” may be associated with the top two keys in each of the first and second key rows in the upper light corner as illustrated in FIG. 7. When the operator's finger engages one of these keys, the “word processing” icon will be highlighted in an appropriate manner, such as illustrating a fingerprint image on the icon, or changing the illumination of the icon, etc. This indicates to the operator that the appropriate keys for energizing the icon are being touched. When the operator is satisfied that this is the desired choice, the keys are either touched a second time or are depressed more firmly, to energize the desired function of the device.

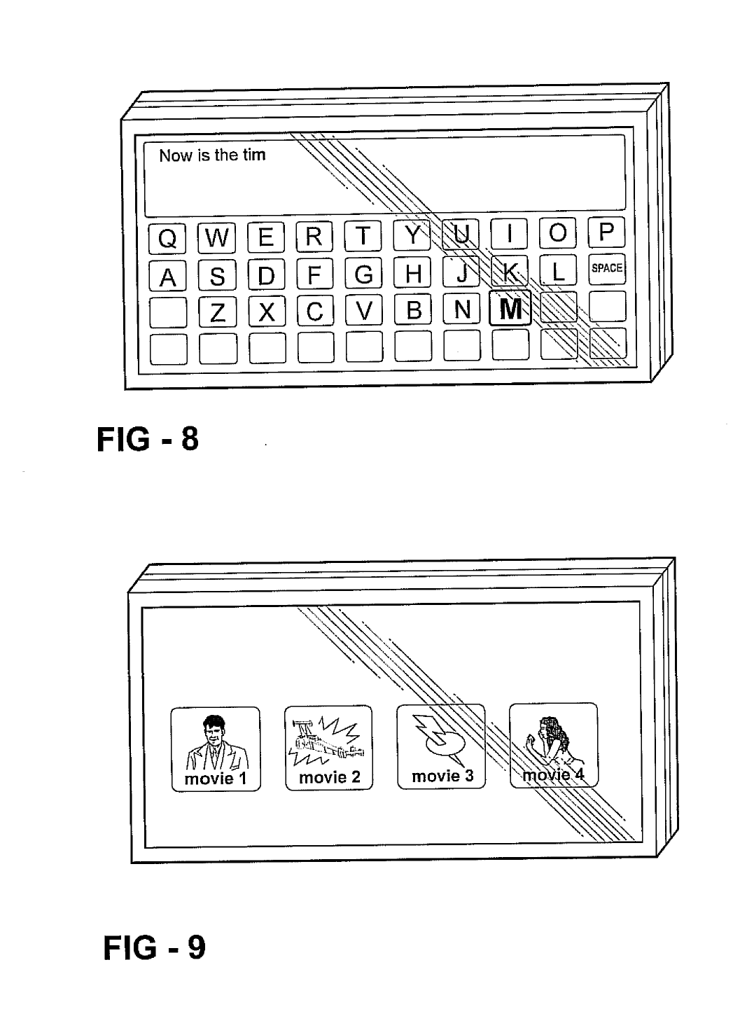

When the “word processing” icon is thus appropriately energized the display screen will change to the form illustrated in FIG. 8. This illustrates a normal QWERTY key configuration. By actuating the key in the last row and second over from the left of the key array as illustrated in FIG. 8, the keys may be switched to a numerical and symbol keypad. The third key over from the left in the bottom row could change the key configuration to a navigation and page up/page down type keys. Accordingly, the three screens will provide a full functional keyboard. In alternative embodiments all of the key functions could be provided in one keyboard. Again, the key functions can be implemented by touching and then tapping or pressing harder any one of the keys. When a key is touched it is highlighted in the manner of the M key on the display screen in FIG. 8. As the operator types using these keyboard sets, the text generated is displayed on the top portion of the display screen 42. It may then be stored, printed out, transmitted as an email or the like.

FIG. 9 illustrates the front display screen 42 when the “movies” icon has been appropriately actuated. It provides a user with a choice of movies which may be selected using the keys or a cursor controlled by the rear touch screen 52 which are then displayed to the user. The keys may be used to control the advancement of the movie in the normal manner.

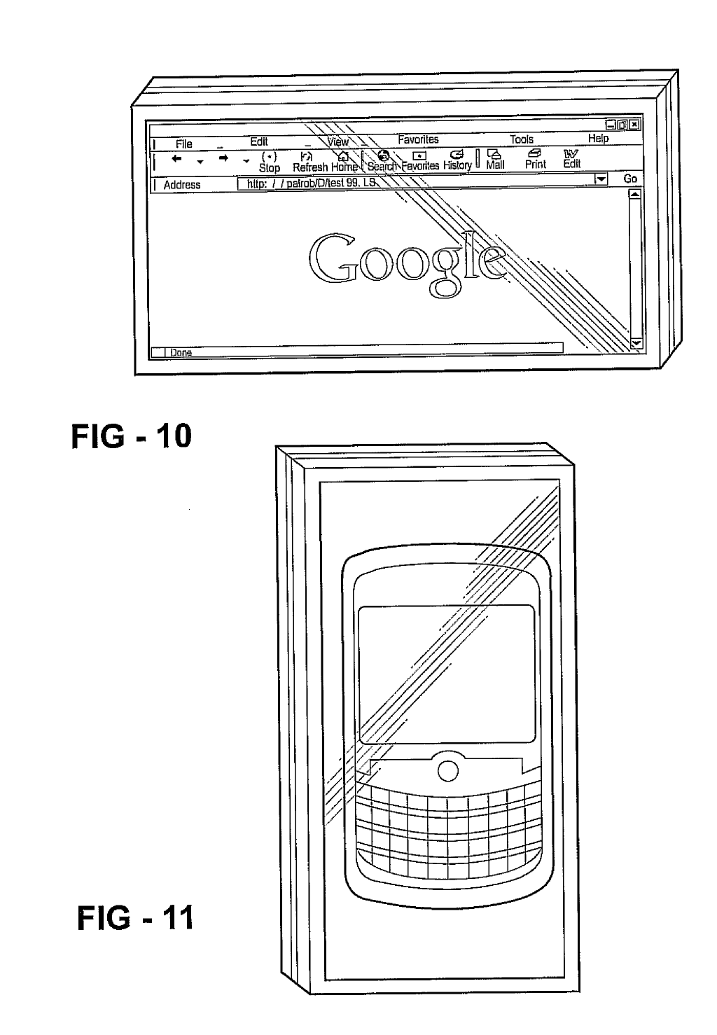

FIG. 10 illustrates the front display screen 42 when the “Internet” icon has been chosen. The user may then actuate the keys to navigate the Internet and choose websites for display in the normal manner of any computer.

FIG. 11 illustrates the front display screen 42 when the “phone” icon has been appropriately actuated using the rear command and data entry structure. The display shows a typical cell phone, and the controls of the phone may then be actuated by signals from the rear command and data entry structure in the same manner as if the user actually held the phone. The same technique may be used to allow the device of FIGS. 6 and 7 to emulate any handheld electronic communication device, such as any TV remote control, automobile keyless entry device, or the like. The device of the present invention is thus a universal handheld electronic communicator.

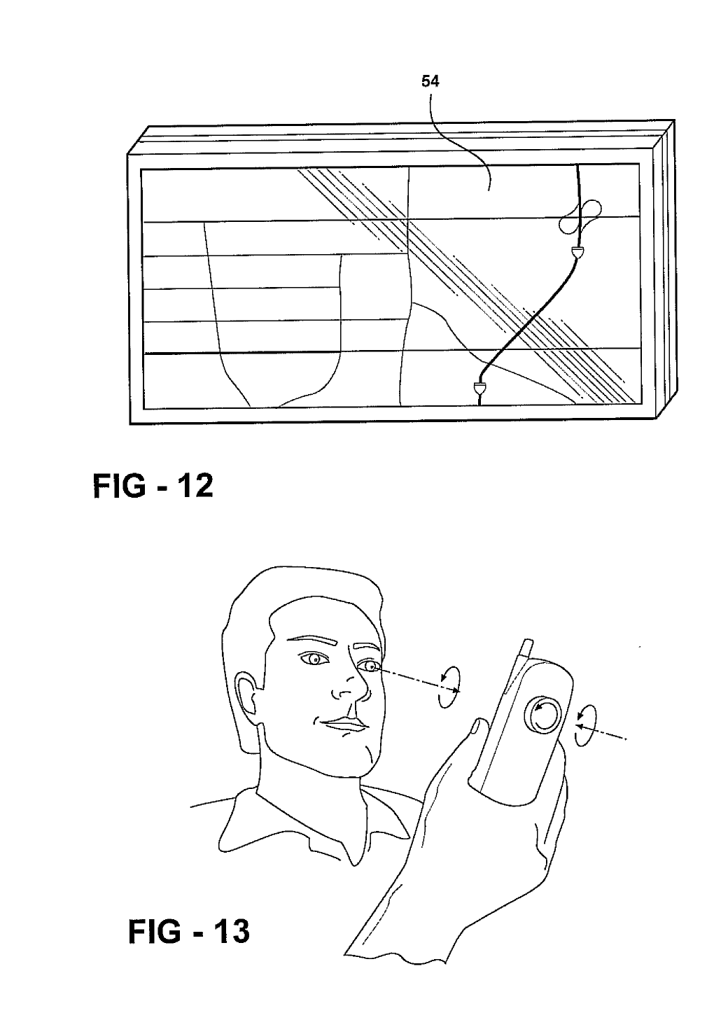

FIG. 12 shows the display screen when the “GPS” icon has been actuated using the command and data entry structure on the rear of the device. A map 54 is displayed and the map area may be changed and particular locations may be zoomed, etc. through use of the command and data entry structure on the rear of the device.

In all of these devices, the interaction with the hand on the command and display structure will produce a reverse mirror image on the front display screen. As a simple example, in the word processing arrangement of FIG. 8 in order to actuate the B key in the upper left-hand corner of the display screen, it is necessary to actuate the key in the upper right-hand corner of the keyboard as viewed from the rear in FIG. 7. Similarly, a motion to the left on the touch screen 52 on the rear of the device will produce a corresponding motion of the cursor being controlled on the front display screen to the light.

FIG. 13 illustrates the manner in which a finger interacting with a rotational navigation control 60 on the rear of an embodiment 62 of the present invention will appear to a user viewing the front display screen as producing a clockwise motion 64. Essentially, motions in the up or down direction are the same on the rear control as on the front display, but motions to the left and right are reversed in the same manner as a mirror reverses an image to the observer.

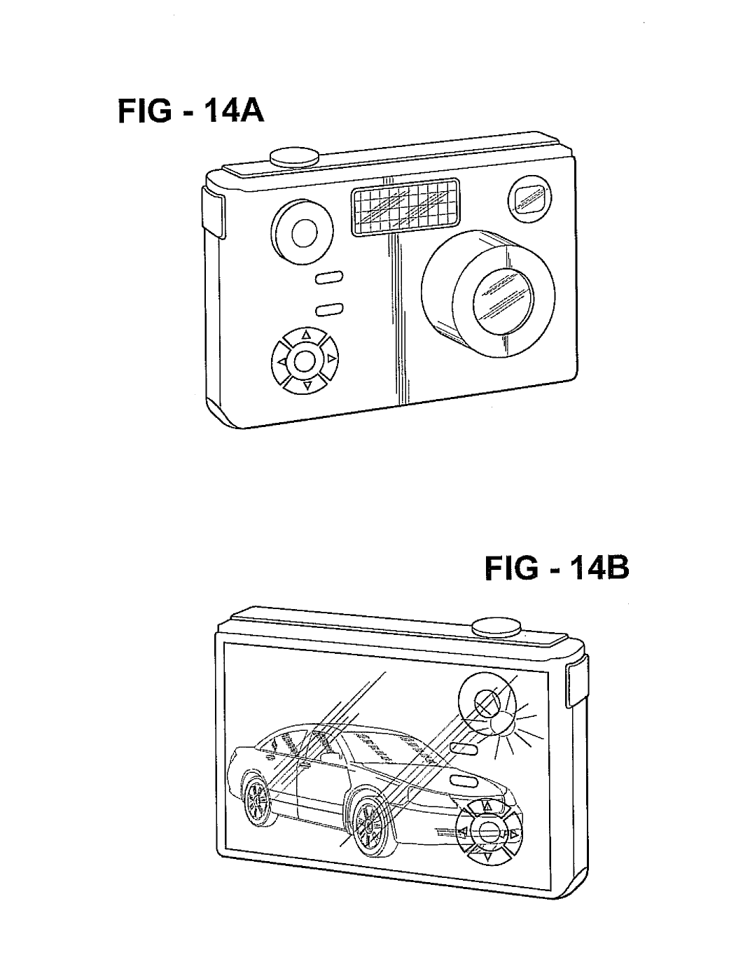

FIGS. 14A and 14B illustrate, respectively, the front in FIG. 14A and the rear in FIG. 14B of a camera formed in accordance with the present invention. The camera, generally indicated at 70, has a rear face (which faces the observer and is thus the equivalent of the front face of the other embodiments of the invention) fully occupied by a display screen 72. The front of the camera includes a lens structure 74, which may be a zoom lens, a navigation button 76 and appropriate control button 78 on the top of the device. The controls on the front are imaged in the display screen at 76.

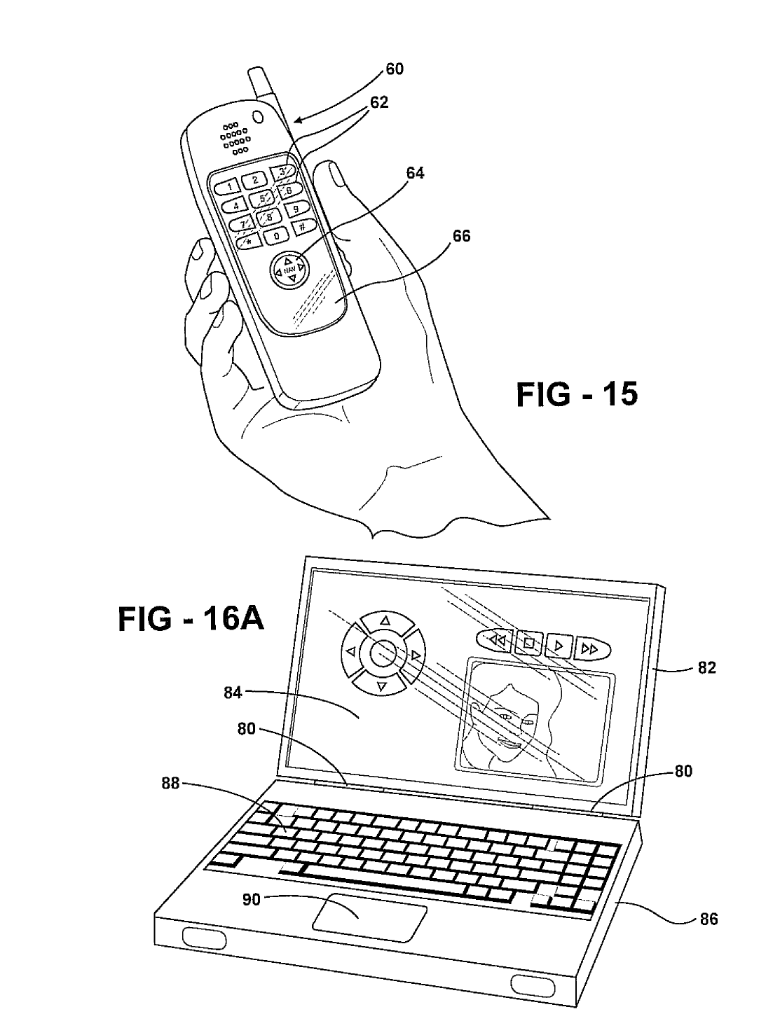

FIG. 15 illustrates an alternative embodiment of the present invention in the form of a cell phone, generally indicated at 60, viewed from the front. The rear side of the device (not shown) constitutes a command and data entry structure which preferably constitutes a plurality of buttons which correspond to the display areas 62, a navigation ring which corresponds to the display area 64, all shown on a display screen 66. The device has a mouse pad at the top, in the back, that the user is using with his pointer finger. This type of operation is one handed. Other embodiments with the mouse pad at or near the top can similarly be used with one hand. The entire front constitutes a display screen which generates the images of the command structure on the opposite side. The large screen provides room for video conferencing, web surfing and the like.

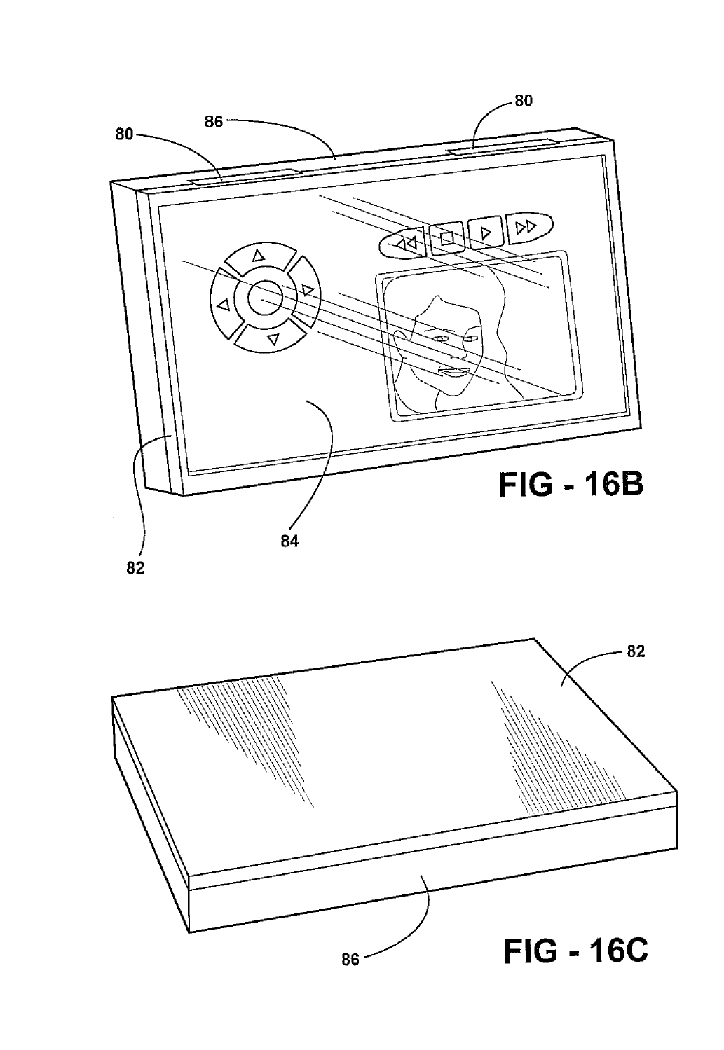

FIGS. 16A-16C illustrate an embodiment of the invention having reversible hinges 80 joining a first module 82, which is rectangular in form and incorporates a display screen 84 on one face and a second rectangular module 86 having a data and command entry structure consisting of a keyboard 88 and mouse pad 90. In the position shown in FIG. 16A the display screen 88 is upwardly inclined from the keyboard 88 and the device may be used in the manner of a conventional notebook PC.

Alternatively, the sections 82 and 86 may be folded about the hinges 80 to the form shown in FIG. 16B, in which the device is formed in accordance with the other embodiments of the invention with the display screen 84 and the keyboard 88 disposed on opposite sides of the structure, parallel to one another and facing in opposite directions. In this form it may be used as a handheld device with the screen 84 held toward the user's face and the user's fingers arrayed on the keyboard 88.

Alternatively, the two modules 82 and 86 may be folded in the opposite direction about the hinges 80 so that the screen 84 abuts the keyboard 88, in a closed configuration, as shown in FIG. 16C.

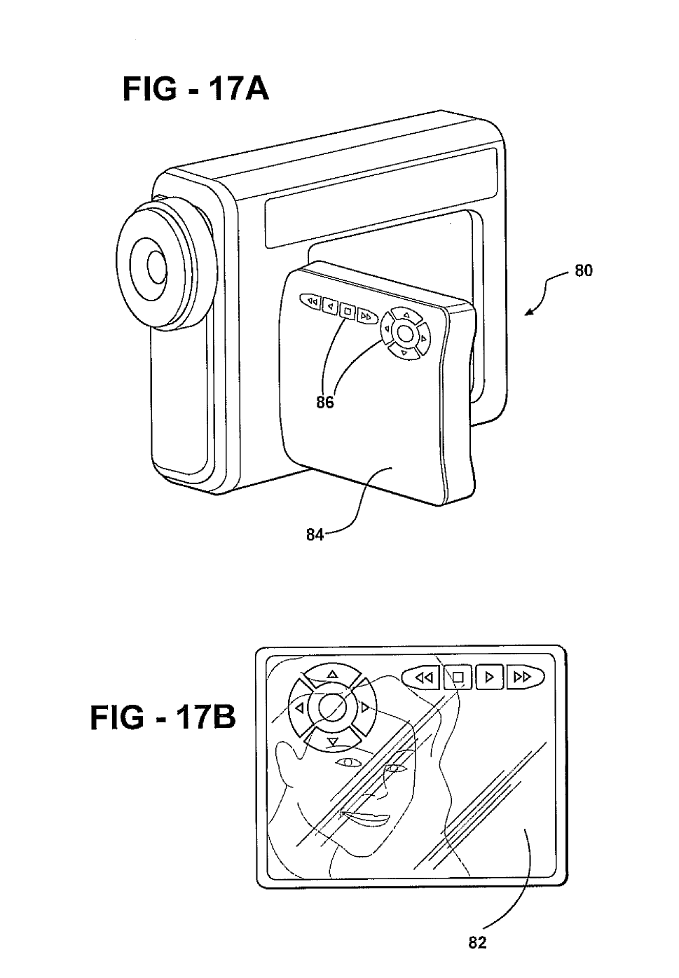

FIGS. 17A and 17B respectively constitute a front perspective view of a video camera embodying the present invention generally indicated at 80, and an image on the display screen 82 of the video camera, which faces rearwardly toward the observer when incorporated in a swivel door 84. The swivel door has the various finger actuated control structures 86 on its forward side and the full display screen 82 on its rearward side. The operator can thus hold the video camera with the right hand, actuate the controls 86 with the left hand and fully operate the video camera.

Having thus described my invention, I claim:

1. An electronic device having a first planar surface consisting of a display screen on one side and a second planar surface, substantially parallel to the first planar surface, on the opposite side incorporating a command and data entry structure which comprises a plurality of keys, the device incorporating electronic circuitry which generates an image on the display screen which mirrors the arrangement of the keys on the second planar surface; the device adapted to be hand supported so that the first planar surface is visible to the user and the user's fingers are arrayed on the second planar surface; the circuitry being adapted to modify the images of particular keys which are touched by the user's fingers; and circuitry for implementing the function of a key when a displayed key is subsequently depressed.

2. The handheld electronic device of claim 1 wherein the command and data entry structure supported on the second planar surface of the device further comprises a touch screen and the circuitry within the device includes means for implementing functions displayed on the first planar surface under control of finger motions on the touch screen.

3. The handheld electronic device of claim 1 wherein the spacing between the first and second planar surfaces is substantially less than the dimensions of the device in directions parallel to the planes of said planar surfaces.

4. The handheld device of claim 1 wherein the key structure comprises a typing keyboard and images of the keyboard are displayed on the screen of the first planar surface.

5. The handheld electronic control system of claim 1 wherein the keys on the second planar surface are arrayed as an alphanumeric keyboard; the system displays images of the keys on the lower portion of the display screen on the first planar surface; and images of selected keys are sequentially displayed on the upper half of the display screen on the first planar surface.

6. The handheld electronic device of claim 1 wherein the device can be switched into any one of a plurality of functional arrangements and icons representing the differing functional arrangements are arrayed on the display screen on the first planar surface of the device and are selected by the depression of particular keys on the keyboard on the second planar surface of the device.

7. The handheld electronic device of claim 6 including circuitry within the device for generating an indicating change on one of the icons when the key associated with that icon is depressed and for actuating the function represented by the icon when an indicated key is touched a second sequential time.

8. The device of claim 6 wherein the keys are arrayed in a BGTYHN configuration whereby the fingers of the user's hands holding the device at its opposite edges in two hands are arrayed over the keys in the same manner that a conventional typist's fingers are arrayed over the keys of a QWERTY keyboard, allowing a user to touch type on the rear of the device.

9. A handheld electronic device having a first planar surface supporting a display screen and a second, opposed, substantially parallel planar surface carrying a keyboard, the keyboard being arranged in a BGTYHN configuration derived by splitting a QWERTY keyboard vertically into two sections, rotating each section through ninety degrees in opposed directions, and flipping the resulting configuration through one hundred eighty degrees about a vertical axis, whereby when the device is held by a user with two hands on opposed sides of the device and the user's fingers on the rear of the device, the fingers will be arrayed on the keyboard in a manner similar to the array of a conventional typist's fingers on a QWERTY keyboard.

10. The handheld electronic device of claim 9 further including a touch panel on the second planar surface operative to control the movement of a cursor visible on the display screen to select functions visible on the display screen.

11. The handheld electronic device of claim 9 wherein a keyboard and touch screen disposed on the second planar surface of the device are represented by images displayed on the display screen in a mirrored arrangement with respect to the keys and touch screen on the opposite side.

12. The handheld electronic device of claim 9 in which each icon generated on the display screen is associated with a plurality of contiguous keys on the keyboard and when any one key is touched, the icon is highlighted to indicate the key touched.

13. The handheld electronic device of claim 6 wherein at least one of the icons represents a word processing configuration in which the keys on the second planar surface of the device are arrayed as a keyboard and images of the keys are generated on the display screen and may be selected by actuating certain of the associated keys.

14. The handheld electronic device of claim 6 wherein the device includes a memory storing a plurality of video sequences and in one configuration the device allows the user to select a particular video selection for display on the screen.
